(19) United States
(12) Patent Application Publication
(10) Pub. No.: US 2025/0086814 A1
(43) Pub. Date: Mar. 13, 2025

(54) SYSTEMS AND METHODS FOR LEARNING-BASED MULTI-LAYER MATERIAL INSPECTION WITH MODEL-BASED MASKS

(71) Applicant: Mitsubishi Electric Research Laboratories, Inc., Cambridge, MA (US)

(72) Inventors: Pu Wang, Cambridge, MA (US); Toshiaki Koike-Akino, Belmont, MA (US); Petros Boufounos, Winchester, MA (US); Wataru Tsujita, Tokyo (JP)

(73) Assignee: Mitsubishi Electric Research Laboratories, Inc., Cambridge, MA (US)

(21) Appl. No.: 18/466,124

(22) Filed: Sep. 13, 2023

(51) Int. Cl. G06T 7/50; G06V 10/28; G06V 10/44; G06V 10/82

(52) U.S. Cl. CPC G06T 7/50; G06V 10/28; G06V 10/44; G06V 10/82

(57) ABSTRACT

A method of image reconstruction of a structure of a scene comprises collecting measurements of intensities of a wave over a period of time. The intensities of the wave are modified by propagation of the wave in the scene. The method also comprises collecting depth information indicative of the structure of the scene at different values of depth of the scene. The different values of depth correlate with different time segments forming the period of time. The method also comprises processing the measurements with a guided recurrent neural network to sequentially learn features of the structure of the scene using the depth information as a guidance and rendering one or multiple images indicative of the features of the structure learned by the recurrent neural network.

### TECHNICAL FIELD

This disclosure generally relates to pixel identification techniques for inspection of scenes, and more specifically to multi-layer imaging systems and methods utilizing a recurrent neural network that learns features from spectrogram segments with masks from model-based sparse deconvolution.

### BACKGROUND

See-through sensing is important for many applications such as microwave imaging, bio-microscopy, medical imaging, through-the-wall imaging (TWI), infrastructure monitoring, and seismic imaging. In particular, the see-through sensing enables the visualization of the internal structure of the material and characterization of its physical properties. For example, in microwave imaging, the see-through sensing provides the structure of objects. In bio-microscopy, the see-through sensing allows visualization of the internal cell structure in three dimensions. In TWI, the see-through sensing allows to compensate for the delay of the signal propagating through the wall.

There are generally two basic approaches for scene understanding used by radar, Lidar, THz sensing, and other technologies. First is a model-based approach such as sparse reconstruction that uses the physics of propagation of a wave in the usually sparse structure of the scene. Another approach is a data-driven approach such as reconstructing a scene with a neural network trained with machine learning. Both of these approaches have their pros and cons and can be advantageous for different scenarios of scene reconstruction. However, for some applications, both of these approaches can be suboptimal.

Accordingly, it is desirable to have scanning techniques that are of hybrid nature and that combine beneficial aspects of both the data driven approaches and model-based approaches.

### SUMMARY

It is an objective of some example embodiments to provide techniques for multi-layer material inspection. It is also an objective of some example embodiments to provide a hybrid scanner for image reconstruction of a structure of a scene that takes a synergy from both the data-driven and sparse reconstruction methods. Some example embodiments are also directed towards such hybrid scanners and methods for image reconstruction of a structure of a scene that can complement different portions of different parts of the architecture of the neural network with results of the sparse reconstruction.

Some example embodiments are based on a realization that the use of terahertz (THz) wave for multi-layer material inspection has a number of advantages for contactless sensing in factory automation and maintenance under adversarial conditions (e.g., fire and smoke), and robustness to dust and dirt. Nevertheless, the inspection results may vary subject to humidity, pixel-to-pixel depth variation due to vibration, and the lack of layer identification.

Some embodiments are based on recognizing that data-driven and sparse reconstruction methods can address different drawbacks of the scene reconstruction caused by the specifics of the scene. For example, sparse reconstruction is more resilient to the disturbance caused by vibration, while the data-driven method is advantageous to reduce shadow effects of the inner scattering of different objects and/or layers of the scene. To that end, it is an objective of some embodiments to provide a hybrid scanner for image reconstruction of a structure of a scene that takes a synergy from both the data-driven and sparse reconstruction methods.

However, the nature of the data-driven and sparse reconstruction methods makes such a synergy challenging. Indeed, the neural network is a black box with sometimes unknown logic learned through machine learning. In contrast, the sparse reconstruction methods use signal models and recovering algorithms carefully designed based on the physics of signal propagation. Some embodiments are based on the understanding that some synergy can be achieved by post-processing of results of the scene reconstruction performed by different methods. However, such post-processing may lose the advantage of cooperative scene understanding gained during the execution of different methods. Some embodiments are based on the understanding that the post-processing may not be enough, and, to achieve such a synergy, the operations of different internal steps of the data-driven methods should be complemented by sparse reconstruction.

To that end, it is an objective of some embodiments to provide a system and a method that can make use of the operation of the sparse reconstruction methods with the internal operation of the data-driven methods implemented with neural networks. Additionally, or alternatively, it is an objective of some embodiment to provide such a hybrid scanner for image reconstruction of a structure of a scene that can complement different portions of different parts of the architecture of the neural network with results of the sparse reconstruction.

Some embodiments are based on recognizing the relationship between the depth of the scene and the time of collecting measurements of the wave propagated within a scene. Indeed, the deeper portions of the depth of a scene are measured later than shallow portions of the depth in dependence on reflection or refraction used for wave propagation. Hence, different segments of the depth of the scene can be mapped to different time segments within a period of time for collecting the measurements. Notably, such a mapping can be done in advance in dependence on hardware and specifics of sensing application.

With this understanding, some embodiments are based on recognizing that information of different depth segments produced by sparse reconstruction can complement different parts of the architecture of the neural network if the architecture of the neural network would incorporate in itself the notion of time. An example of such an architecture is a recurrent neural network including a sequence of recurrent units that sequentially learn features of the structure of the scene and aggregate the time-dependent features over time or depth. In the recurrent neural network, each of the recurrent units can be associated with a time segment from the sequence of time segments forming the period of time for collecting the measurements and mapped to a corresponding depth segment of a structure of the scene estimated by the sparse reconstruction. Doing this in such a manner allows for incorporating different findings of the sparse reconstruction into specific parts of the architecture of the neural network to improve the accuracy of sparse reconstruction.

In order to achieve the aforesaid objectives and advancements, some example embodiments provide systems, methods, and computer program products for image reconstruction of a structure of a scene.

Some example embodiments provide a scanner for image reconstruction of a structure of a scene. The scanner comprises a memory configured to store instructions and at least one processor configured to execute the instructions to cause the scanner to collect measurements of intensities of a wave over a period of time. The intensities of the wave are modified by propagation of the wave in the scene. The scanner collects depth information indicative of the structure of the scene at different values of depth of the scene. The different values of depth correlate with different time segments forming the period of time. The scanner processes the measurements with a guided recurrent neural network to sequentially learn features of the structure of the scene using the depth information as a guidance. The depth information is aligned with the measurements according to the correlation between the depth values and the different time segments. The scanner renders one or multiple images indicative of the features of the structure learned by the recurrent neural network.

In yet some other example embodiments, a computer-implemented method for image reconstruction of a structure of a scene is provided. The method comprises collecting measurements of intensities of a wave over a period of time. The intensities of the wave are modified by propagation of the wave in the scene. The method also comprises collecting depth information indicative of the structure of the scene at different values of depth of the scene. The different values of depth correlate with different time segments forming the period of time. The measurements are processed with a guided recurrent neural network to sequentially learn features of the structure of the scene using the depth information as a guidance. The depth information is aligned with the measurements according to the correlation between the depth values and the different time segments. One or multiple images indicative of the features of the structure learned by the recurrent neural network are rendered as output.

In yet some other example embodiments, a non-transitory computer readable medium having stored thereon computer executable instructions for performing the method for image reconstruction of a structure of a scene is provided.

In some example embodiments the measurements are processed with a sparse reconstruction network to recover a sparse structure of the scene along its depth and the sparse structure is quantized into a sequence of bins corresponding to a sequence of depth segments along the depth of the scene, such that each bin includes a quantized value of the sparse structure for a corresponding depth segment of the sequence of depth segments, wherein the sequence of bins has a one-to-one mapping with a sequence of time segments forming the period of time.

In some example embodiments, the guided recurrent neural network includes a sequence of recurrent units that sequentially learn the features of the structure of the scene. Each of the recurrent units is associated with a time segment from the different time segments forming the period of time. A recurrent unit of the sequence of recurrent units may be configured to learn at least some features of the structure of the scene based on an output of a previous iteration, a portion of the measurements collected over an associated time segment, and a quantized value of a bin mapped to the associated time segment.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of an image processing system for reconstructing images of a structure of a target, according to some example embodiments;

FIG. 1B illustrates a flowchart of a method for image reconstruction of a structure of a scene, according to some example embodiments;

FIG. 1C illustrates schematics of a raster scanning operation performed on a multi-layer object for training a guided recurrent neural network, according to some example embodiments;

FIG. 2A illustrates a workflow of a multi-layer inspection module, according to some example embodiments;

FIG. 2B illustrates a schematic of an exemplar target structure with shadowing effect, according to an example embodiment;

FIG. 2C illustrates a framework followed by a multi-layer inspection module for identifying pixel content over a target structure, according to some example embodiments;

FIG. 3A illustrates a block diagram of a scanning engine for reconstructing images of a target, according to some example embodiments;

FIG. 3B illustrates a schematic diagram showing information processing by various components of a multi-layer inspection module, according to some example embodiments;

FIG. 4 shows a cross-section of layered structure of a target object along a path of wave propagation to illustrate some principles of an inspection module for generating content labels of the modified waves according to some embodiments;

FIG. 5 illustrates a schematic of image reconstruction using deconvolved responses according to one embodiment;

FIG. 6A illustrates a flowchart of a method for generating sparse depth profile of a target, according to some example embodiments;

FIG. 6B illustrates a graphical representation of the sparse depth profile of the target, according to some example embodiments;

FIG. 7 illustrates a flowchart of a method for learning-based THz multi-layer pixel identification for non-destructive inspection, according to some example embodiments;

FIG. 8A illustrates a schematic of using a single THz transceiver for target scanning, according to some example embodiments;

FIG. 8B illustrates a schematic of using multiple THz transceivers for target scanning, according to some example embodiments;

FIG. 8C illustrates a schematic of using a single THz transceiver together with collimating optics at THz band for scanning, according to some example embodiments;

FIG. 8D illustrates a schematic of using a THz transmitter and a THz receiver separated on both sides of a multi-layer non-overlapping sample, according to some example embodiments;

FIG. 9 shows a schematic of an automation system including a scanner, according to some embodiments; and

FIG. 10 illustrates a block diagram of a computer-based information system in accordance with some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

See-through sensing is important and essential for many applications such as microwave imaging, bio-microscopy, medical imaging, through-the-wall imaging (TWI), infrastructure monitoring, and seismic imaging. In particular, the see-through sensing enables the visualization of the internal structure of the material and characterization of its physical properties. Recently there have been increased interests in terahertz (THz) sensing, in either a reflection or a transmission mode, due to the broad applications in gas sensing, moisture analysis, non-destructive evaluation, biomedical diagnosis, package inspection, and security screening. The THz sensing systems are able to inspect not only the top surface of the sample but also its internal structure, either a defect underneath the top layer or a multi-layer structure, due to its capability of penetrating a wide range of non-conducting materials.

In a number of situations, the structure of a target object is indeed layered. For example, a target object can be a man-made object with a layered structure, such as a stack of papers, where each sheet of paper is a layer in that multi-layer structure, a semiconductor device formed by layers of different materials, and infrastructure extended underground at different depths. In other situations, however, a target object can be a natural object with a layered structure, such as human tissue having multiple layers. In yet some other situations, the target objects do not have a clearly observed layered structure, but still can be treated as a combination of layers.

Reconstructing the images of such layered structures using electromagnetic waves has been a difficult task due to shadow effects caused on each layer by a preceding layer. As such, treating objects as layered structures and attempting to reconstruct images of each layer leads to degradation in the image quality of deeper layers. Specifically, the multi-level image reconstruction suffers from shadow effect due to the non-uniform penetrating of the wave from front layer to deeper layers. This problem can be conceptualized as a structure of one layer casting a shadow on subsequent layers and that shadow can be considered as the structure of the subsequent layers. In such a manner, the shadow effect contributes to the artifacts in the image reconstruction of the deep layers. As such, better approaches for image reconstruction of layered objects are still desired.

Some solutions are based on a data-driven approach such as reconstructing a scene with a neural network trained with machine learning. Some other solutions are based on a model-based approach such as sparse reconstruction methods that use the physics of propagation of a wave in the usually sparse structure of the scene. Some embodiments recognize that data-driven and sparse reconstruction methods can address different drawbacks of the scene reconstruction caused by the specifics of the scene. To that end, it is an object of some embodiments to provide a hybrid scanner for image reconstruction of a structure of a scene that takes a synergy from both the data-driven and sparse reconstruction methods. In this regard, some example embodiments achieve such a synergy by complementing the operations of different internal steps of the data-driven methods by sparse reconstruction. Therefore, according to some example embodiments a neural network configured to reconstruct images of layers of a scene is assisted or guided using depth profile information of the scene that is generated using a model-based approach that uses the physics of propagation of a wave in the structure of the scene. Such a guidance to the neural network is provided in a time synchronized manner since some portions of the depth of a scene are measured differently in time (earlier or later) than shallow portions of the depth.

These and several other aspects of various example embodiments will now be described with reference to the figures.

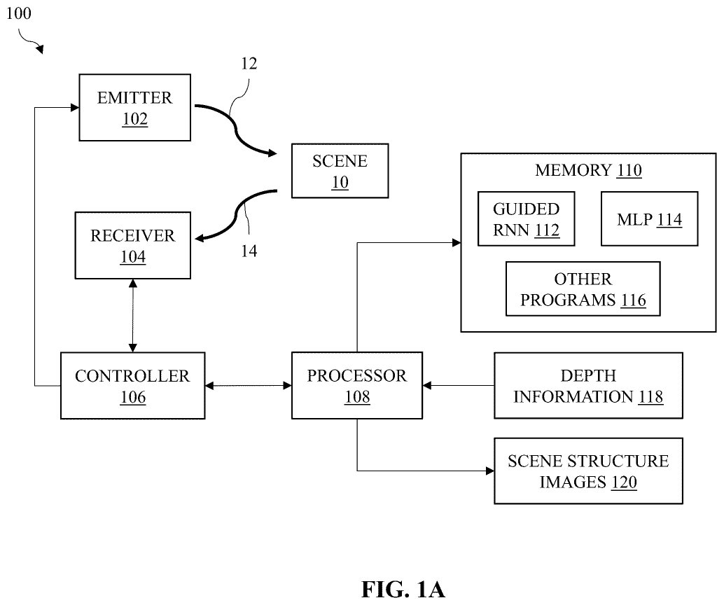

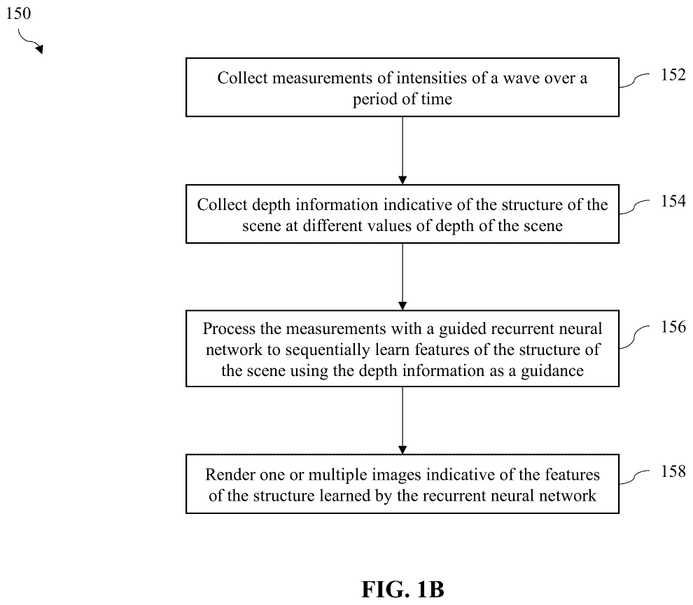

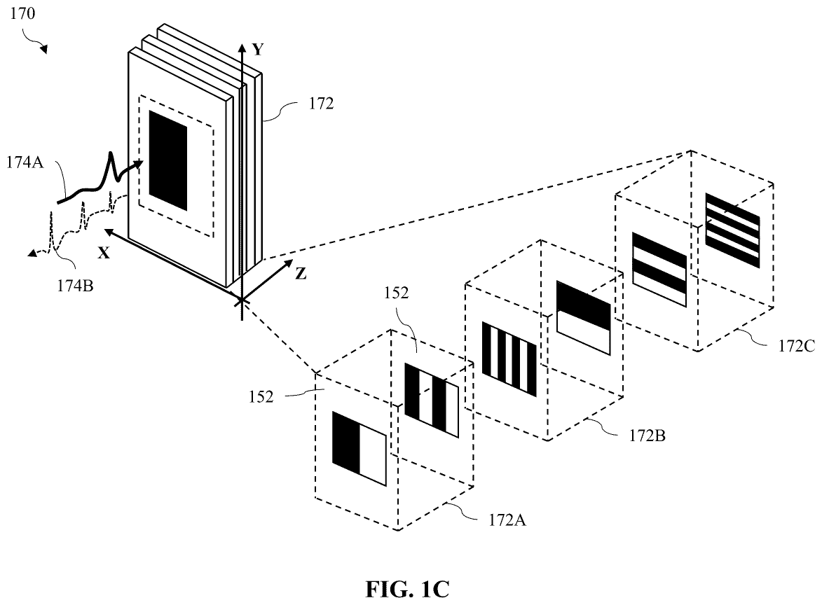

FIG. 1A illustrates a block diagram of an image processing system 100 for reconstructing images of a structure of a target 10, according to some example embodiments. The target 10 may comprise a scene of one or more objects of interest that may be subject to inspection. In this regard, the image processing system 100 comprises a transceiver system including an emitter 102, a receiver 104, and a controller 106. The emitter 102 is configured to irradiate the scene 10 with one or more suitable radiation waves 12. The receiver 104 receives reflected or refracted waves 14 from the target 10. The waves 14 may be understood to be a reflection or refraction of the incident waves 12 from the target 10 and as such the intensities of the incident waves 12 may be modified due to penetration through the target 10. The intensities of the received waves 14 may be those modified intensities of the incident waves 12. A task of scanning the target 10 may include the actions of transmitting one or more incident waves towards the target 10 and collecting the components of the incident waves after they have propagated through the target 10. Towards this end, the transceiver system may be movable at least in part to perform the scanning of the target 10 along different directions with varied degree of freedom. For example, the transceiver system may perform raster scan of the target 10 with a single transceiver or an array of transceivers. In some example embodiments, the transceiver may perform compressed scan of the target 10.

The receiver 104 may comprise suitable circuitry for receiving the waves 14 from the target and the controller 106 reads the intensities, frequencies, wavelengths and or other information related to the waves 14. The controller 106 provides the readings of the waves 14 to a processor 108 of the image processing system 100 for further processing. The configuration of the transceiver system defined by the emitter 102, the receiver 104, and the controller 106 may take various forms according to desired needs or operating conditions.

For example, in some example embodiments the transceiver system may take the form of a permittivity sensor system for determining an image of distribution of permittivity of the target 10. In some embodiments, the permittivity sensor system may propagate one or more waves 12 through the material of a target object in the target 10 and receive a set of echoes in the form of waves 14 resulted from scattering the pulse by different portions of the material. The pulse may be any type of electromagnetic or optical waves, such as one or combination of a microwave pulse, a radar pulse, a laser pulse, an ultrasound pulse, an acoustic pulse. In some example embodiments, the emitter 102 may be a transmitter and the receiver 104 may be arranged at a predetermined location with respect to the transmitter for receiving the set of echoes 14. For example, in one embodiment, the receiver 104 and the emitter 102 may be located on the same side of a target object in the target 10 such that the echoes 14 include propagation and reflections of the emitted waves 12. In a different embodiment, the receiver 104 and the emitter 102 may be located on different sides of the target object in the target 10, such that the emitted waves 14 are modified by the propagation through the material of the target object. According to different embodiments, the permittivity sensor can aid in production of a two- or three-dimensional image of the material of the target where each location in the image provides the value of the dielectric permittivity for a portion of material corresponding to that location.

In some example embodiments, the emitter 102 includes a collimator to collimate the wave to a broad beam, and a spatial encoder to spatially encode the broad beam with a random mask. In addition, the receiver 104 includes a focusing lens to focus the reflected wave, and a single-pixel photoconductive detector receiving the focused wave from the focusing lens to provide one measurement of the wave 14 at a time allowing to recover the image of the multi-layer structure using a sparse reconstruction. It is contemplated that different embodiments use different types of emitters selected based on an expected structure of the target object and desired type of image reconstruction. Examples of the emitter 102 include optical, ultrasound, and x-ray emitters. Some embodiments use terahertz (THz) emitters emitting within a terahertz frequency range, e.g., from 0.3 to 3 terahertz with corresponding wavelengths from 1 mm to 0.1 mm (or 100 μm). Because THz scanners are sensitive to non-uniform penetrating illumination from front layers to deep layers, the joint-layer hierarchical image recovery benefits these kinds of emitters.

The processor 108 may be communicatively and operationally coupled with a memory 110 and the controller 106. The processor 108 collects the measurements of intensities of the waves 14 over a period of time that may be referred to as a collection time period. The memory 110 stores various modules and programs of the image processing system 100. For example, the memory 110 stores a guided recurrent neural network (RNN) 112, a multilayer perceptron (MLP) network 114, and other programs 116. The processor 108 invokes the guided RNN 112 for image reconstruction of the structure of the target 10. In this regard, the processor 108 collects depth information 118 indicative of the structure of the target 10. The depth information 118 may be indicative of the structure of the scene at different values of depth of the target 10. The different values of depth (i.e., depth segments) correlate with different time segments forming the period of time (i.e., the collection time period).

According to some example embodiments, the processor 108 may collect the depth information 118 indicative of the structure of the target 10 as a model-based output from one or more programs of the other programs 116. In some example embodiments, the depth information 118 may be known beforehand and the processor 108 may obtain the depth information 118 from a storage device coupled with the processor 108. For example, the depth information 118 may be stored in a suitable storage medium such as the memory 110 or a cloud-based storage.

The image processing system 100 is based on the understanding that information of different depth segments produced by sparse reconstruction complements different parts of the architecture of the RNN 112 since the architecture of the RNN incorporates in itself the notion of time. In some example embodiments, the guided RNN 112 includes a sequence of recurrent units that sequentially learn the features of the structure of the target 10. In this regard, the guided RNN 112 may include a plurality of long short-term memory network (LSTM) units or a plurality of gated recurrent units (GRU). In the guided RNN 112, each of the recurrent units is associated with a time segment from the different time segments forming the collection time period. Also, each recurrent unit is mapped to a corresponding depth segment of a structure of the target 10 estimated by the sparse reconstruction provided as the depth information 118. Doing this in such a manner allows for incorporating different findings of the sparse reconstruction into specific parts of the architecture of the neural network 112 to improve the accuracy of sparse reconstruction.

According to some example embodiments, a recurrent unit of the sequence of recurrent units of the RNN 112 learns at least some features of the structure of the target 10 based on an output of a previous iteration, a portion of the measurements collected over an associated time segment of the collection time period, and a quantized value of a bin mapped to the associated time segment. The depth information 118 serves as a guidance for the guided RNN 112 to modify an RNN update step by utilizing the sparse deconvolution depth profile provided by the depth information 118. Details regarding the structure and operation of the guided RNN 112 are provided later in this disclosure.

Having obtained the measurements of intensities and the depth information 118, the processor 108 processes the measurements with the guided RNN 112 to sequentially learn features of the structure of the target 10 using the depth information 118 as a guidance. The depth information 118 is aligned with the measurements according to the correlation between the depth values and the different time segments. The processor 108 generates multi-layer content labels corresponding to the measurement intensities using a decoder program from the memory 110. The content labels are expressed as binary values where a 0 indicates that a corresponding pixel has no output while a 1 indicates the corresponding to have an output. These content labels are collated by the processor 108 and organized according to the arrangement of the pixels to obtain one or more images 120 of the structure of the target 10. The processor 108 outputs these one or multiple images indicative of the features of the structure learned by the recurrent neural network 112.

Some steps performed by the image processing system 100 for image reconstruction of a structure of the target 10 are shown in FIG. 1B which illustrates a flowchart of a method 150 for image reconstruction, according to some example embodiments. Referring to FIG. 1B, measurements of intensities of a wave modified due to propagation through the target 10 are collected 152 over a period of time. Further, the depth information 118 indicative of the structure of the target 10 at different values of depth of the scene are also collected 154. The collected measurements are processed 156 with a guided recurrent neural network such as the guided RNN 112 of FIG. 1A, to sequentially learn features of the structure of the target 10 using the depth information 118 as a guidance. One or multiple images indicative of the features of the structure learned by the guided recurrent neural network are rendered 158 as output in the manner described with reference to the images 120 of FIG. 1A.

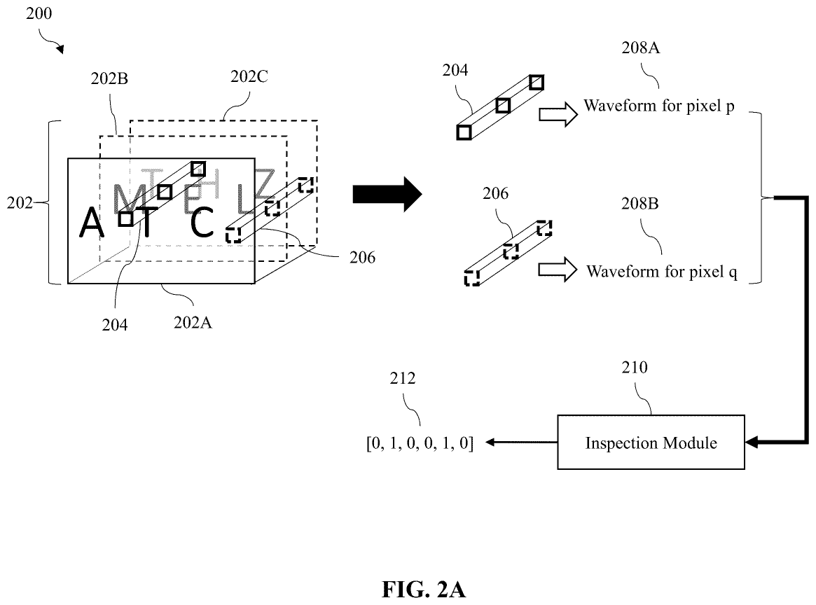

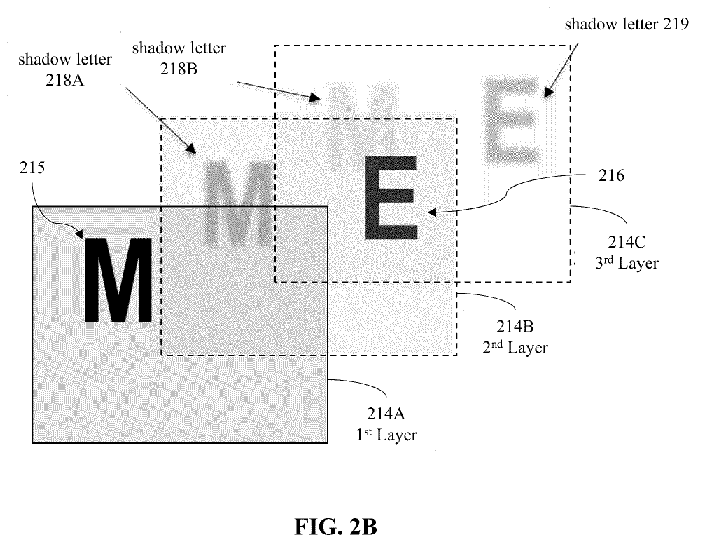

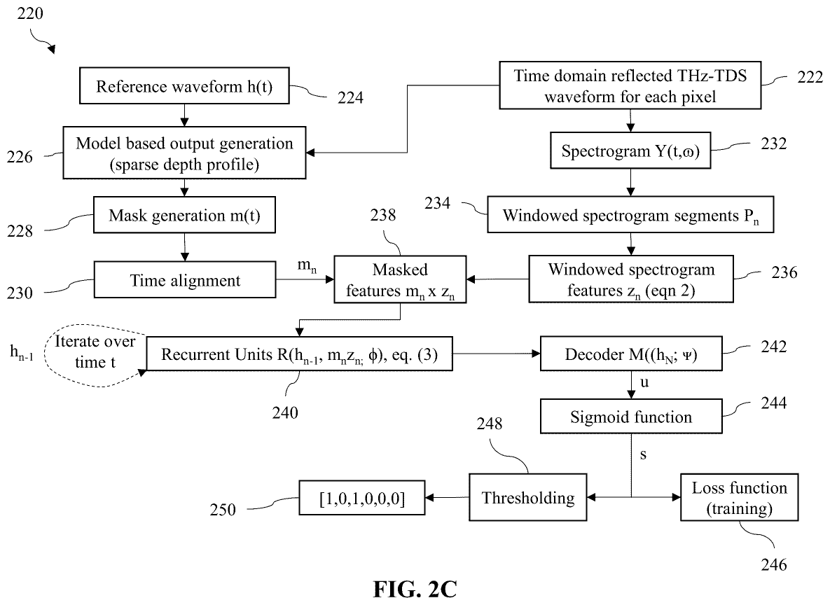

FIG. 1C illustrates schematics of a raster scanning operation performed on a multi-layer object 172 for training the guided RNN 112, according to some example embodiments. In some example embodiments, the object 172 may be a stack of three sheets of printed paper, thereby forming a three-layer sample. Both front and back surfaces of each paper sheet (i.e., layer) may include some content. The content area may be divided into even number of patches. Each pixel corresponds to a unique binary label c. For instance, c=[1, 0, 1, 0, 1, 0] implies that all front surfaces, as observed by the corresponding pixel, are covered by the drawing while the back surfaces, as observed by the corresponding pixel, are blank. The scanning step size may be selected as per desired granularity of the reflected waveforms. For example, if the pixel size is n×n mm, and the scanning step size is s mm, a set of (n×n)/s² waveforms for each pixel may be obtained. In some example embodiments, the waveforms may be randomly split into training, validation, and test datasets in predefined percentages. For example, 60% of the waveforms may be selected as training dataset, 10% of the waveforms may be selected as validation dataset, and 30% of the waveforms may be selected as test dataset for training phase of the guided RNN 112 of FIG. 1A. The training dataset may be augmented by shifting the waveform and adding Gaussian noise to improve the invariance to the depth variation. The guided RNN 112 is trained on the dataset to predict binary content labels for the structure of the object 172. The guided RNN 112 may be initiated with random weights. The training waveforms are then fed to the recurrent NN branch and the model-based branch (i.e., to the entity generating the depth information 118) with the reference waveform. The loss function is then calculated as in step 246 of FIG. 2C which is described later. The loss is then backpropagated back through the guided RNN 112 and the weights are updated to gradually reduce the training loss. Over a number of iterations, the trained weights of the guided RNN 112 are frozen and the loss over the validation waveforms is checked. The training weights with the smallest validation error are then used for inference on the test waveforms.

FIG. 2A illustrates a workflow of a multi-layer inspection module 210 used by some embodiments of see-through image reconstruction. The embodiments are based on realization that the shadow effect considered as a disadvantage in image reconstruction using signal processing can be turned into an advantage for a hybrid approach for image reconstruction. Specifically, due to complication caused by the shadow effect, the wave that has penetrated the layered structure of a scene is uniquely modified by the structure of the materials and objects present in the scene. On the other hand, such a unique modification is stable.

As used herein, uniquely modified means that if a scene or a target object has a first structure on a first path of propagation of a first wave penetrating the scene or the target object and a second structure on a second path of propagation of a second wave penetrating the scene or the target object and the first structure is different from the second structure then the first wave modified by penetration would be different from the second wave modified by penetration even if before the modification the first and the second waves are identical. Also, as used herein, the stable modification means that if a scene or target object has a first structure on a first path of propagation of a first wave penetrating the scene or the target object and a second structure on a second path of propagation of a second wave penetrating the scene or the target object and the first structure is the same as the second structure then the first wave modified by penetration would be the same as the second wave modified by penetration, when before the modification the first and the second waves were identical. In such a manner, a wave modified by penetration through the scene, or the target object leaves a unique and stable signature indicative of the structure of the scene or the object on the path of penetration, as the case may be.

Referring to FIG. 2A, a target structure 202 that is subject to inspection by the inspection module 210, includes three layers 202A, 202B, and 202C. The inspection module 210 analyzes the target object 202 along a depth direction that is aligned to the direction of propagation of an incident wave. In the exemplar scenario illustrated in FIG. 2A, the depth direction may be orthogonal to a two-dimensional plane in which a layer of the target object 202 lies. In this manner, the target object 202 may be modelled as a stack of the layers 202A-202C. As such, the voxels 204 and 206 extending into the direction of wave propagation include the waves 208A and 208B, respectively. The waves 208A and 208B are modified due to the scattering by material of the layers 202A-202C. This scattering is complicated to ensure that if the material of the voxels 204 and 206 are different from each other, then the modified waves are different from each other as well. However, the scattering acts in a stable manner, so if multiple waves repeatedly propagate through material of the voxel 204, then the propagated wave 208A would have similar signature.

In some example embodiments, the inspection module 210 may be executed as a combination of hardware and software. In this regard, the inspection module 210 may be embodied as a combination of the processor 108 and the memory 110 of FIG. 1A, and other interfaces and components as may be required. The inspection module 110 may also be interfaced with other circuitries and components such as a transceiver system that scans the target object 202. In this regard the transceiver system may perform raster scanning on the target object 202. As such the transceiver may scan the multi-layer target object 202 sequentially over horizontal and vertical directions and provide one or more waveforms corresponding to each pixel reading of the scan. That is, one or more time-domain waveforms are collected for each pixel. The waveforms for two such pixels are labeled as 208A and 208B.

Each of the waveforms 208A, 208B corresponds to a unique pixel of the image of the structure of the target object 202. For example, the waveform 208A may correspond to a pixel p of the image of the structure of the target object 202 while the waveform 208B may correspond to a pixel q of the image of the structure of the target object 202. The inspection module 210 may sequentially process the measurements of the waveforms 208A, 208B to generate binary content labels 212 corresponding to the images of the structure of the target object 202. In this regard the inspection module 210 may utilize the processor 108 and the memory 110 of FIG. 1A. In such a manner, the guided recurrent neural network 112 can be trained to process the modified waves 208A, 208B into, e.g., vectors of labels 212 that can be used to reconstruct the image of the target object 202. In addition, in various embodiments the neural network of the inspection module 210 is trained to generate a content label for each pixel of the image of the structure of the target object 202. As such, the sequence of labels corresponds to the sequence of layers of the target object 202, such that a segment of modified wave corresponds to a layer having the same index in the sequence of layers as an index of the segment in the sequence of labels. In the exemplar scenario illustrated in FIG. 2A, the binary content labels 212 are shown as a sequence of six binary values each representing a front or back surface of a 3-layer sample such as the target object 202. The number of layers may be determined in advance or adaptively determined from model-based output.

FIG. 2B illustrates a schematic of an exemplary structure of a target object with the shadowing effect, according to one embodiment. In this example, the target object may have a layered structure, for example, a stack of three sheets of paper.

Specifically, some embodiments are based on recognition that the images of the layers 214A-214C of the target object can be reconstructed individually and/or jointly. Some embodiments reconstruct the images using sparse reconstruction by fitting reconstructed images into the measurements of the intensities of the reflected wave. Such a sparse reconstruction is performed with regularization to prevent overfitting. Different embodiments perform the individual and/or joint reconstruction of the layers by selecting an appropriate regularization. For example, for individual reconstruction, the regularizations are individual for each layer. In contrast, for a joint reconstruction, the regularization is a joint regularization determined as a weighted combination of individual regularizations of the layers.

Some embodiments are based on recognition that the multi-level image reconstruction suffers from shadow effect due to the non-uniform penetrating of the wave from front layer to deeper layers (for example from layer 214A to layer 214C). This problem can be conceptualized as a structure of one layer casting a shadow on subsequent layers and that shadow can be considered as the structure of the subsequent layers. In such a manner, the shadow effect contributes to the artifacts in the image reconstruction of the deep layers.

Referring to FIG. 2B which also shows a schematic of the shadow effect of patterns from front layers to deep layers, the pattern 215 of a letter ‘M’ appears at the first layer 214A of the structure of a target object and the pattern 216 of a letter ‘E’ appears at the second layer 214B of the structure. Due to the non-uniform penetration, a shadow letter 218A of ‘M’ appears on the second layer 214B and another shadow letter 218B of ‘M’ also appears on a third layer 214C. Likewise, a shadow letter 219 of ‘E’ appears on the third layer 214C. It is an object of some embodiments to recover the patterns/letters ‘M’ and ‘E’ even in the presence of shadow effect.

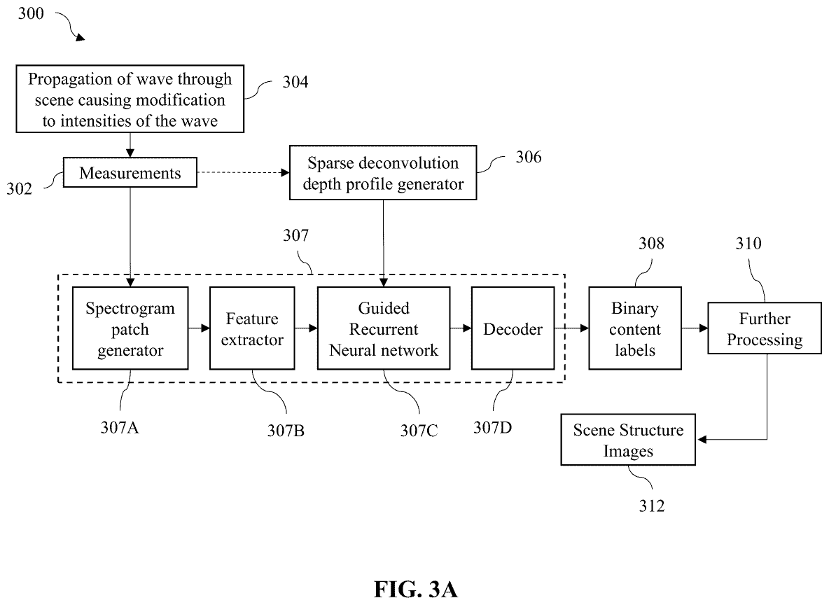

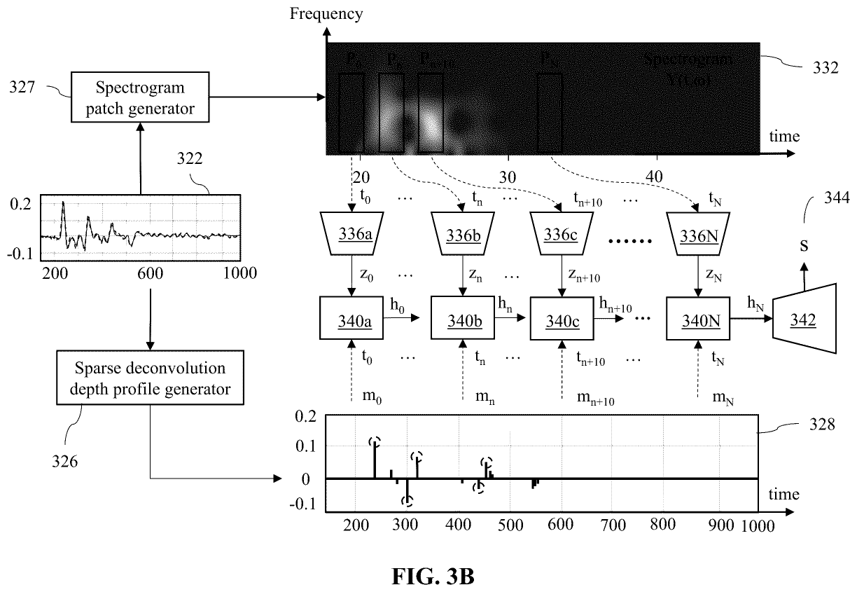

FIG. 2C illustrates a framework 220 followed by a multi-layer inspection module for reconstructing images of a target structure, according to some example embodiments. The framework 220 is a hybrid approach in at least the aspect that it combines principles of a data-driven approach such as reconstructing a scene with a trained neural network trained with training data and a model-based approach such as sparse reconstruction methods that use the physics of propagation of a wave in the usually sparse structure of the scene. Such a meaningful amalgamation of the data-driven and sparse reconstruction approaches is able to provide a robust solution to the underlying image reconstruction problem since each of these approaches caters to at least some different drawbacks. Particularly, in the framework 220 illustrated in FIG. 2C, some principles of the sparse reconstruction approach supplement and assist the neural network of the data-driven approach, thereby providing a reliable solution to a longstanding problem. Accordingly, the framework 220 provides a deep learning-based approach to deal with challenges from 1) depth variation due to the platform vibration and motion 2) shadow effect caused by non-uniform penetrating illumination from front layers to deep layers, for example, as is shown in FIGS. 2B, and 3) the impact of humidity conditions.

The framework 220 considers the use of terahertz (THz) wave for multi-layer material inspection. The THz waves aid in inspection of not only the top surface of the sample but also its internal structure, either a defect underneath the top layer or a multi-layer structure, due to its capability of penetrating a wide range of non-conducting materials. Accordingly, the framework 220 may find applications in a wide range of areas such as but not limited to gas sensing, moisture analysis, non-destructive evaluation, biomedical diagnosis, package inspection, and security screening.

Referring to FIG. 2C, according to the framework 220, for each pixel, at least one time domain THz reflected waveform 222 is collected from the scene.

A time-frequency spectrogram representation 232 of the time-domain THz waveform 222 is obtained. In some example embodiments, time-frequency spectrogram 232 may be obtained using a short-time Fourier transform (STFT) as:

$$Y ( t , ω ) = \int y ( τ ) {g}^{*} ( τ - t ) {e}^{- i ω τ} d τ$$

where g(t) is a time-domain localized window function and ω is the frequency variable. The spectrogram |Y(t, ω)|² is divided into time-dependent two-dimensional (2D) patches given by:

$${P ( {t}_{n} ) = \{ \vert y ( t , ω ) ) \vert}^{2} \vert t ∈ 𝒯 ( {t}_{n} ) , ω ∈ F ( {ω}_{n} ) \}$$

In some example embodiments, [symbol] (tₙ)={t|tₙ−0.5T_{ω}≤t<tₙ+0.5T_{ω}}, where T_{ω} is the window size used and ωₙ ∈[0, 0.5 ωₛ] where ωₛ is the sampling frequency. This renders a sequence of 2D spectrogram patches/segments 234 sliding over the time (depth) domain:

$${P}_{n} {=}^{Δ} P ( {t}_{n} , ω ) , n = 1 , 2 , … , N .$$

The windowed spectrogram segments Pₙ 232 are passed through a feature extraction network [symbol] (Pₙ, θ) (for e.g., a convolution neural network) parametrized by θ to produce a latent representation zₙ∈ [symbol] ^{d} given by:

$${z}_{n} = ( {P}_{n} , θ ) , n = 1 , … , N \qquad ( 2 )$$

Here zₙ represents the windowed spectrogram features.

A reference waveform h(t) 224 is also obtained. The reference waveform 224 may be obtained prior to the inspection using a fully reflective mirror at the THz band. The reference waveform 224 is utilized to obtain a single reflected waveform that contains the impact from the air absorption due to the humidity. The reference waveform 224 is utilized together with the time domain THz waveform 222 for model-based output generation of the sparse depth profile 226. In this regard, the time domain THz waveform 222 represented as y(t) is expressed as a convolution between a sparse depth-wise layer profile f(t) and the reference waveform h((t) 224 as

$$y ( t ) = h ( t ) ⊗ f ( t ) = {\int }_{- ∞}^{∞} h ( τ ) f ( T - τ ) d τ .$$

By sampling the waveform y(t) with a sampling interval Tₛ, the discrete-time waveform representation of the time domain THz waveform 222 is obtained as:

$${y}_{n} = y ( n {T}_{s} ) = {\sum }_{m = 0}^{M} {h}_{m} {f}_{n - m} + {e}_{n} ,$$

where hₘ=h(mTₛ) is the reference sample and fₙ=f(nTₛ) is the depth profile at corresponding time instances, and eₙ is the measurement noise. Equivalently, the sampled waveform may be expressed in a matrix-vector form as y=Hf+e, where H is the convolution matrix whose rows are cycle-shifted, reversed versions of the reference signal h^{T}. The following [symbol] ᵢ regularized least square—LASSO—is used to identify sparse depth profile as a model-based output 226:

$$\hat{f} = {arg min}_{f} \frac{1}{2} {‖ Hf - y ‖}_{2}^{2} + λ {‖ f ‖}_{1} , \qquad ( 1 )$$

where we resort to the fast iterative shrinkage-thresholding algorithm (FISTA).

The framework 220 requires that the spectrogram patch features obtained at 236 be propagated over time using a recurrent neural network (RNN), for example a long short-term memory network (LSTM). Particularly, the RNN is trained to sequentially update time-dependent latent (hidden) variables hₙ using the previous latent variable hₙ₋₁ and the current spectrogram feature zₙ:

$${h}_{n} = ( {h}_{n - 1} , {z}_{n} ; ϕ ) , n = 1 , 2 , … , N ,$$

where [symbol] represents an RNN unit (such as an LSMT unit) with trainable parameters ϕ shared over all time steps. To account for the depth-wise layer structure, the framework 220 modifies the above RNN update step by utilizing the sparse deconvolution depth profile 226 i.e., \hat{f} of eqn. (1). In this regard, the framework 220 comprises generation of masked features mₙzₙ 238 from the windowed spectrogram features zₙ 236 and masks 228 generated by a masking function m(t). The generated masks 228 are aligned 230 in time to the windowed spectrogram features zₙ such that the different values of zₙ correlate with the different time segments and the scalar masks mₙ also correlate one to one with unique values of zₙ and time. The time alignment module 230 may compensate the sampling discrepancies between the model-based and data-driven branches. Furthermore, the masked features can be more generalized than the product form. For instance, the masked feature can be a nonlinear function of mₙ and zₙ, parameterized by a feedforward neural network. The masked features mₙzₙ 238 are provided to the recurrent units 240 to obtain:

$${h}_{n} = ( {h}_{n - 1} , {m}_{n} {z}_{n} ; ϕ ) , n = 1 , 2 , … , N , \qquad ( 3 )$$

where mₙ∈{0,1} is a scalar mask given by mₙ= [symbol] (|\hat{f}|≥∈) with ∈ given as a predetermined threshold. The propagation of the masked features is iterated over time t.

The framework 220 also requires a decoder 242 for which, the last latent variable h_{N} is enforced to predict the multi-layer binary content labels with a standard multilayer perceptron (MLP) network as

$${u}_{n} = ( {h}_{N} , ψ ) , \qquad ( 4 )$$

where ψ consists of the MLP weight matrices and bias terms. The (weighted) multi-label binary classification is used with each label precisely corresponding to a binary label (i.e., {0, 1}) for each surface. To this end, the output u is converted to a score vector s ∈[0, 1] using a sigmoid function 244 given as sₙ=(1+e^{-u}^{ₙ})⁻¹. Then, the total loss takes the weighted average of the N individual losses as:

$$L = - \frac{1}{N} {\sum }_{n = 1}^{N} {ω}_{n} {c}_{n} log ( {s}_{n} ) , \qquad ( 5 )$$

pwhere ωₙ is the weight on the n-th surface. The above loss function L is utilized during the training phase of the RNN. The binary imaging result 250 is obtained by comparing s with a threshold 248. In some example embodiments the threshold may be 0.5.

Although, the framework 220 considers THz waves for scanning the objects, it may be contemplated that without requiring any major modification, the framework 220 can be extended to work with any other wave capable of penetrating a scene and at least some objects present in the scene. Furthermore, although the framework 220 comprises principles leading to online generation of the sparse depth profile 226, it may be contemplated that within the scope of this disclosure, the sparse depth profile may be available beforehand from a suitable source. As such, an image processing system utilizing the framework 220 generates the sparse depth profile only when it is not available otherwise. An example of one such system is shown in FIG. 3A which illustrates a block diagram of a scanning engine 300 for reconstructing images of a target, according to some example embodiments.

Referring to FIG. 3A, the scanning engine 300 comprises suitable interfaces to collect measurements 302 of intensities of a wave over a period of time. The intensities of the wave are modified by propagation 304 of the wave through a scene. The measurements 302 may be utilized by a sparse deconvolution depth profile generator 306 to generate a sparse depth profile for the scene. In some example embodiments, the sparse deconvolution depth profile generator 306 may be external to the scanning engine 300. In an alternate embodiment, the sparse deconvolution depth profile generator 306 may be part of the scanning engine 300. According to some example embodiments, the sparse depth profile information may be known beforehand, and the scanning engine may obtain it from a suitable source such as a storage device. A central processing unit (CPU) 307 of the scanning engine 300 collects the measured intensities 302 over a collection time period and the sparse depth profile information indicative of the structure of the scene at different values of depth of the scene. It may be noted that the different values of depth correlate with different time segments forming the collection time period.

The CPU 307 comprises a spectrogram patch generator 307A that generates a time-frequency spectrogram representation of the time-domain waveform whose intensities are measured, in a manner similar to that described with reference to the spectrogram 232 of FIG. 2C. A feature extractor 307B of the CPU 307, which may be a CNN produces a latent representation of windowed spectrogram features in a manner similar to that described with reference to the windowed spectrogram features 236 of FIG. 2C. The CPU 307 also comprises a guided RNN 307C similar to the guided RNN 112 of FIG. 1A. The sparse depth profile provided by the depth profile generator 306 and the latent representation of windowed spectrogram features are utilized to obtain masked features that are processed using the guided RNN 307C to sequentially learn features of the structure of the scene using the depth profile as a guidance. Particularly, the trained RNN 307C sequentially updates time-dependent latent (hidden) variables using the previous latent variable (provided by a sequentially previous recurrent unit of the RNN) and the current spectrogram feature (fed to the current recurrent unit). Using the latent variable obtained from the last recurrent unit of the RNN 307C, a decoder 307D predicts multi-layer binary content labels 308.

The multi-layer binary content labels 308 are further processed 310 to obtain the scene structure images 312 of the structure of the scene. In this regard, the multi-layer binary content labels 308 are associated with the model-based output, particularly the dominate peak locations in the sparse depth profile such as 328 of FIG. 3B. In other words, the significant peaks in the model-based output 328 of FIG. 3B are replaced by the output of the guided RNN i.e., the multi-layer content labels. In this way, the content labels are associated with corresponding time or depth information. By iterating the process over all scanned pixels, the content labels may be grouped according to their depth info and reconstruct the content image of each surface of the inspected materials.

FIG. 3B illustrates a schematic diagram showing information processing by various components of a multi-layer inspection module, according to some example embodiments. The multi-layer inspection module may be similar to the module 210 described with reference to FIG. 2A and may be embodied in software or a combination of hardware and software. A time domain reflected THz waveform for a pixel may be of the form as shown as 322 where the original waveform as measured is shown in dotted line while the reconstructed waveform is shown in solid line. The inspection module collects the measured intensities of the reflected waveform over a collection time period. The waveform for each pixel may be different from each other. The reflected waveform may be a representation of amplitude/intensity vs time. A sparse deconvolution depth profile generator 326 similar to the generator 306 generates from the measured reflected waveform 322, the depth profile information 328 which is also plotted as amplitude/intensity vs time. Also, a spectrogram patch generator 327 of the inspection module generates a time-frequency spectrogram representation 332 (i.e., Y(t, ω)) of the time-domain waveform 322 whose intensities are measured, in a manner similar to that described with reference to the spectrogram 232 of FIG. 2C.

A plurality of time-dependent 2D spectrogram patches or segments P₀-P_{N} may be obtained from the time-frequency spectrogram representation 332 as is shown in FIG. 3B. This results in a sequence of 2D spectrogram patches/segments sliding over the time (depth) domain. Each of these patches/segments corresponds to a unique time segment of the collection time period over which the measured intensities of the reflected waveform 322 are collected. For example, as is shown in FIG. 3B, the patch/segment P₀ corresponds to time segment to, the patch/segment Pₙ corresponds to time segment tₙ, the patch/segment P_{N} corresponds to time segment t_{N} and so on.

These patches/segments are submitted to a feature extraction network comprising a plurality of feature extraction units or subnets 336a, 336b, . . . 336N. The number of the feature extraction units may be selected based upon the number of time segments of the collection time period. For example, for N number of time segments there may be N number of feature extraction units in the feature extraction neural network. Each feature extraction unit (336a, 336b, . . . 336N) generates a corresponding spectrogram patch feature (z₀, z₁, . . . z_{N}) in the manner described with respect to equation (2).

A guided RNN comprising a plurality of recurrent units 340a, 340b, . . . , 340N uses the depth profile information 328 as guidance to update time-dependent latent (hidden) variables hₙ using the previous latent variable hₙ₋₁ and the current spectrogram feature zₙ. In this regard, it is contemplated that the number of the recurrent units may be selected based upon the number of time segments of the collection time period. For example, for N number of time segments there may be N number of recurrent units in the guided RNN.

The inspection module utilizes the depth profile information 328 to generate a mask corresponding to each time segment of the collection time period, such that a mask mₐ is a function of the depth profile information f(t) (which is a model-based output) at corresponding time tₙ. Therefore, for N number of time segments there may be N number of masks, one for each recurrent unit of the guided RNN. The masks are scalar masks given by mₙ= [symbol] (|\hat{f}ₙ|≥∈) with ∈ given as a predetermined threshold.

Each recurrent unit [symbol] (340a, 340b, . . . , 340N) updates its latent variable hₙ using the latent variable hₙ₋₁ of an immediately preceding recurrent unit and the spectrogram feature input to the particular recurrent unit. Throughout this disclosure, for a current recurrent unit corresponding to the time segment tₙ, the latent variable hₙ₋₁ of an immediately preceding recurrent unit may also be referred to as the previous latent variable since it corresponds to the immediately previous recurrent unit in sequence as well as to the immediately previous time segment tₙ₋₁. For example, for the recurrent unit 340c the current latent variable is hₙ₊₁₀ and the previous latent variable is hₙ₊₉. Thus, the recurrent units are initialized and iterated over time from an initial time segment to a final time segment of the collection time period. In this manner, the RNN updates the time-dependent latent (hidden) variables by propagating the masked spectrogram features mₙzₙ over time.

A decoder 342 enforces the last latent variable h_{N} output by the last recurrent unit 340N to predict the multi-layer binary content labels which are converted by the decoder 342 to a vector score s 344.

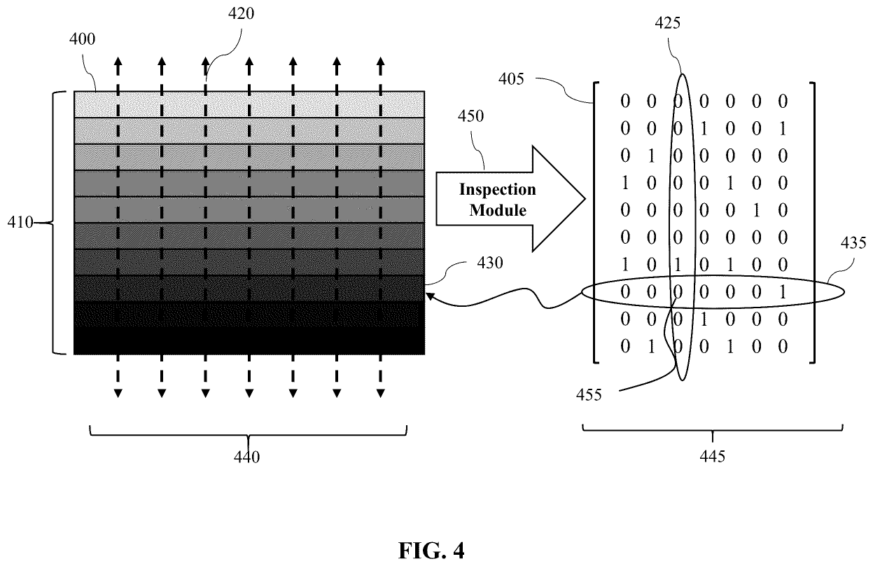

FIG. 4 shows a cross-section of layered structure of a target object along a path of propagation of the wave to illustrate some principles of an inspection module 450 for generating content labels of the modified waves according to some embodiments. The inspection module 450 may be similar to the inspection module 210 of FIG. 2A. In this example, the target object 400 includes 10 layers 410. In some embodiments, the layers 410 may be the physical layers of the structure of the target object 400. In other embodiments, the layers 410 may be considered as an abstraction captured during the training of the neural network of the inspection module 450 according to some embodiments. This is because the number of layers corresponds to the number of outputs of the RNN of the inspection module. For example, if the target object 400 has 10 layers, the output of the neural network generating content labels for a modified wave, such as the wave 420 penetrating the target object 400 includes 10 labels. Similarly, if the output of the RNN includes 10 labels, the target object 400 is considered to have 10 layers.

In such a manner, the index of the layer 430 is the index of a segment of the wave 420 and is the index of the labels 435 in the outputs of the neural network. Such an indexing allows a processor of the inspection module 450 to select the labels 425 having the same index in the outputs of the neural network as labels 435 forming the image of the same layer 430. Similarly, each column of the outputs 405 of the inspection module 450 corresponds to the binary content labels generated for a particular wave. If for example, seven waves 440 penetrate the layers of the object 400 in a single cross section, the outputs of the inspection module 450 include seven vectors 445. For example, a vector 425 corresponds to the content labels of the wave 420. In turn, the wave 420 corresponds to a specific location across all layers allowing to associate a label 455 with both the layer and the location within the layer.

Some embodiments use a 2Lx1 binary content vector (e.g., [0; 0; 0; 0; 0; 0]T) to denote the content over L layers, where 1 means there is ink while 0 denotes no ink in that pixel. These embodiments treat each layer as having two sides. Additionally, or alternatively, in some embodiments a neural network such as a binary classifier may be used to estimate black or white value at a location of a pixel of the image of the layer. Additionally, or alternatively, in some embodiments the neural network may estimate a grayscale value at a location of a pixel of the image of the layer. Additionally, or alternatively, in some embodiments the neural network may estimate a value of permittivity of material of the target object at a location of a pixel of the image of the layer.

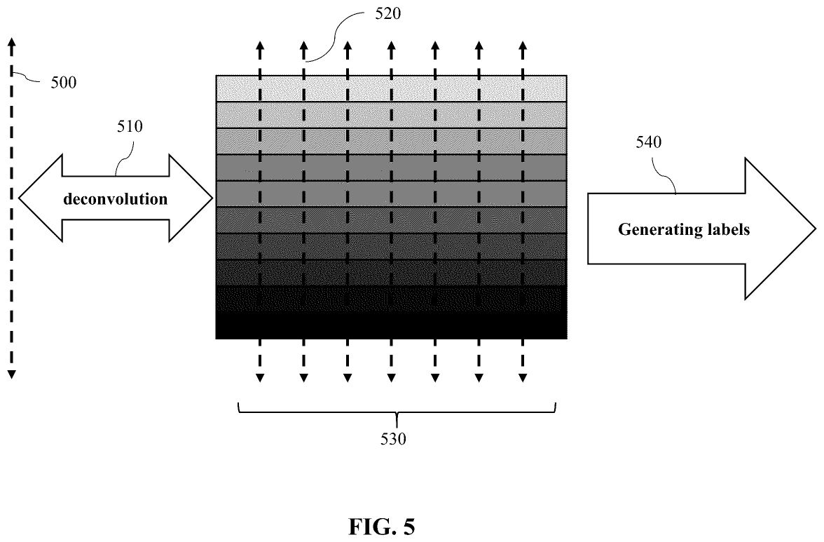

FIG. 5 illustrates a schematic of image reconstruction using deconvolved responses according to one embodiment. In this embodiment, the emitter is configured to emit a reference wave 500 to propagate over the same distance as the modified waves 530 without penetrating the layers of the target object. The embodiment is configured to deconvolve 510 each of the modified waves 530, e.g., a wave 520, with the reference wave 500 to produce a set of deconvolved responses. The neural network is trained for the deconvolved responses of the modified wave to generate binary content labels for the deconvolved response, such that the embodiment determines the image of the layer using the content labels for the set of deconvolved responses. The deconvolution simplifies training of the underlying neural network without altering the quality of image reconstruction.

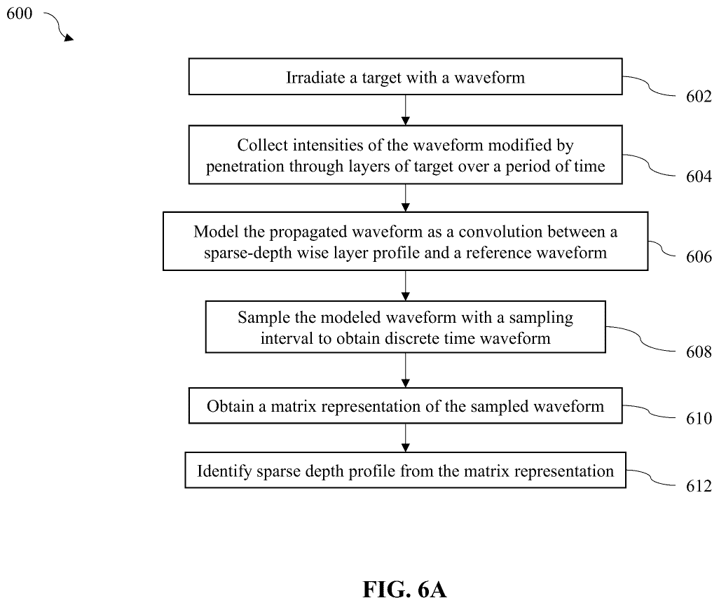

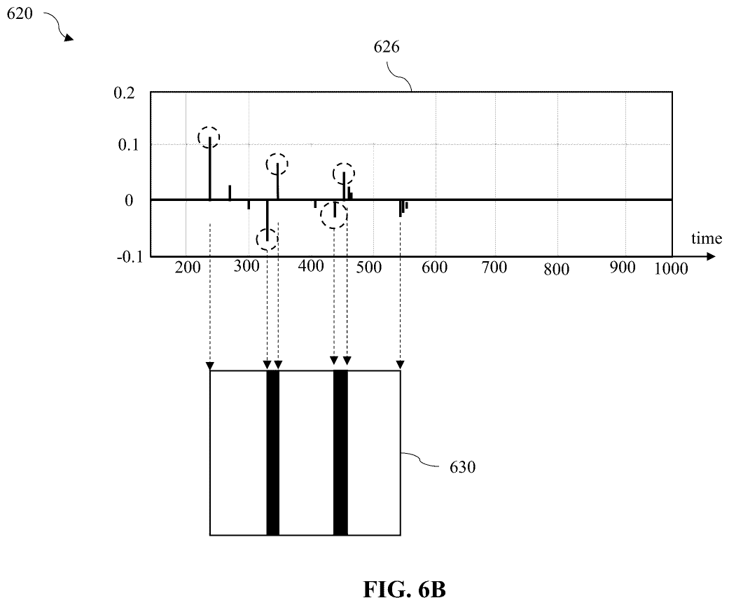

FIG. 6A illustrates a flowchart of a method 600 for generating sparse depth profile of a target, according to some example embodiments. The method 600 comprises irradiating 602 a target with a waveform y(t). The intensities of the waveform get modified as the wave propagates the structure of the target. The intensities of the waveform, modified by penetration through layers of target, are collected 604 over a period of time. The propagated waveform is modeled 606 as a convolution between a sparse-depth wise layer profile and a reference waveform in a manner similar to that described with reference to FIG. 2C. The propagated waveform modeled in this way is sampled 608 with a sampling interval to obtain a discrete time representation yₙ of the waveform. The sampled waveform is expressed 610 in a matrix-vector form as y=Hf+e, in the same manner as described with reference to FIG. 2C. From the matrix vector representation, the sparse depth profile is identified 612 as per equation (1) which is described with reference to of FIG. 2C. In this way, the sparse depth profile or depth information of a target may be generated. The various steps of the method 600 may be executed by a suitable circuitry comprising a mix of software and hardware.

FIG. 6B illustrates a graphical representation of the sparse depth profile 626 of the target, according to some example embodiments. The depth profile 626 is a discrete constrained output f(t) of a model-based approach that uses the physics of propagation of a wave in the sparse structure of the target. Various parameters such as sparsity, smoothness, and total variation of the target may be inferred from the depth profile 626. The exemplar representation illustrated in FIG. 6B considers the value of λ to be 0.2 and the depth profile is represented as a function of amplitude vs time. The peak locations in the profile correspond to the layer thicknesses 630 as assessed using the reference waveform while the peak values correspond to the reflection image. The depth profile can be determined from f(t) over one pixel or jointly over multiple neighboring pixels. For one pixel, one usually ranks the peak magnitudes over the time, which usually decreases over the depth. Smaller peaks among significant peaks may correspond to minor cracks within a layer, rather than a surface. The front surfaces are associated with positive peaks, while the back surfaces are linked to the negative peaks. The layer thickness can be determined by the time difference between a pair of consecutive positive and negative peaks. The model-based deconvolution results are leveraged for temporally masking latent features in the recurrent units.

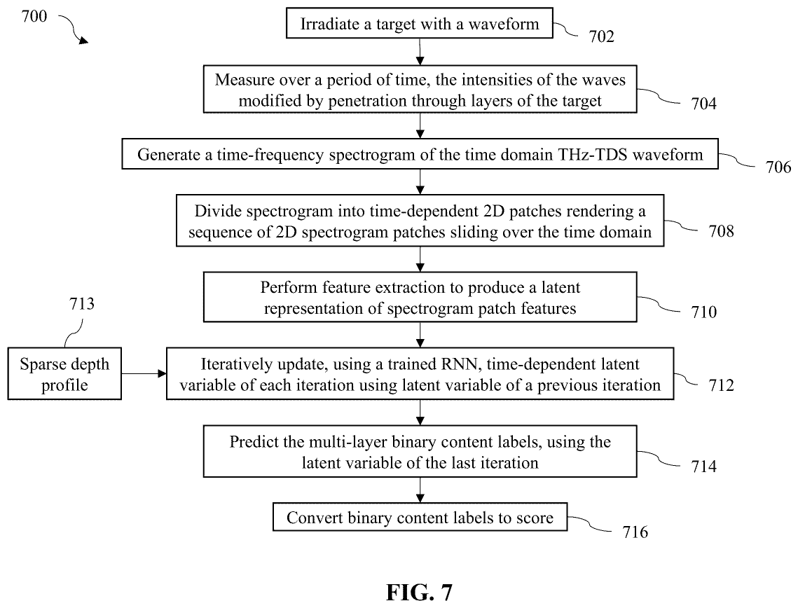

The sparse depth profile identified in the manner described with reference to FIGS. 6A and 6B above may be used by a suitable scanner system to determine scores corresponding to images of the structure of the target. FIG. 7 illustrates a flowchart of a method 700 for learning-based THz multi-layer pixel identification for non-destructive inspection, according to some example embodiments. The method 700 may be executed by the inspection module of FIG. 3B. A target is irradiated 702 with a waveform y(t). The intensities of the waveform get modified as the wave propagates the structure of the target. The intensities of the waveform, modified by penetration through layers of target, are collected 704 over a period of time. A time-frequency spectrogram of the time domain THz-TDS (Terahertz time-domain spectroscopy) waveform is generated 706 in the manner described with respect to the spectrogram patch generator 327 of FIG. 3B. The spectrogram is divided 708 into time-dependent 2D patches rendering a sequence of 2D spectrogram patches sliding over the time domain in the manner described with respect to FIG. 3B. Thereafter, feature extraction is performed 710 on the time-dependent 2D patches to produce a latent representation of spectrogram patch features. The sparse depth profile 713 of the target is also obtained, for example from a suitable storage or from the method 600 of FIG. 6A. A trained recurrent neural network guided using the sparse depth profile 713 is utilized to iteratively update 712 time-dependent latent variable of each iteration using latent variable of a previous iteration and the extracted feature for the current iteration in the manner described with respect to the recurrent units 340a-340N of FIG. 3B. Here the iterations correspond to the sequence of recurrent units of the RNN. The trained RNN predicts 714 the multi-layer binary content labels, using the latent variable of the last iteration of the iterations in the manner described with respect to the decoder 342 of FIG. 3B. The binary content labels predicted are converted 716 into a vector score in the manner described with respect to the decoder 342 of FIG. 3B.

The vector score obtained at step 716 is used to generate the images of the structure of the target. The multi-layer binary content labels 308 are associated with the model-based output, particularly the dominant peak locations in 328 of FIG. 3B. In other words, the significant peaks in the model-based output 328 of FIG. 3B are replaced by the output of the guided RNN i.e., the multi-layer content labels. In this way, the content labels are associated with corresponding time or depth information. By iterating the process over all scanned pixels, the content labels may be grouped according to their depth info and reconstruct the content image of each surface of the inspected materials.

In this way, some example embodiments address the challenges with reconstructing images of layered structures by providing a hybrid approach that leverages both data-driven feature learning and model-based inversion results. To address the depth variation and humidity conditions, time-domain sparsity-regularized deconvolution is applied to enable explainable, high-resolution layer identification with sharp peaks where the forward operation matrix is formed from the cycle-shifted reference waveform as is shown in FIG. 6B. To mitigate the shadow effect, the time-domain THz TDS waveform is transformed into spectrograms with multiple time-frequency resolutions and then grouped into a multi-channel image as input to a recurrent neural network. The recurrent neural network first learns the spatial features of the multi-channel spectrogram segments (within a sliding window) using shared 3D convolution kernels. The learned spatial features are then fed into recurrent units such as LSTM or GRU with shared weights to learn the long-term temporal relation over the spectrogram features. The model-based sparse deconvolution results over the temporal domain are then weighted over the spatial features to control the aggregation of spatial features over time. The latent feature at the final time step is then projected back to the original time domain for waveform reconstruction and to the time domain labels for supervision.

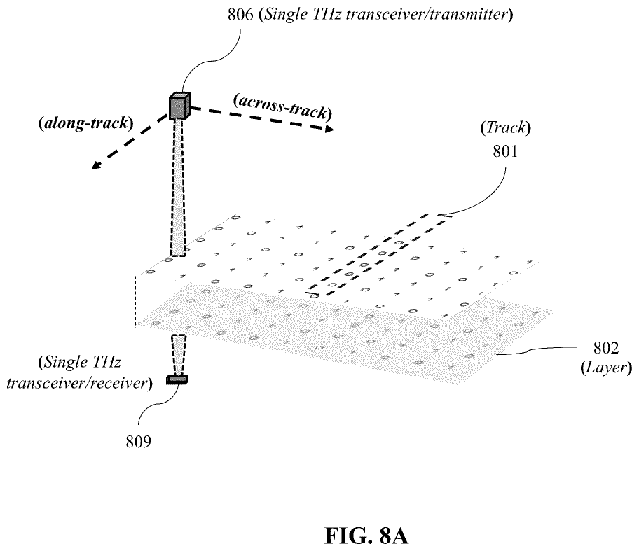

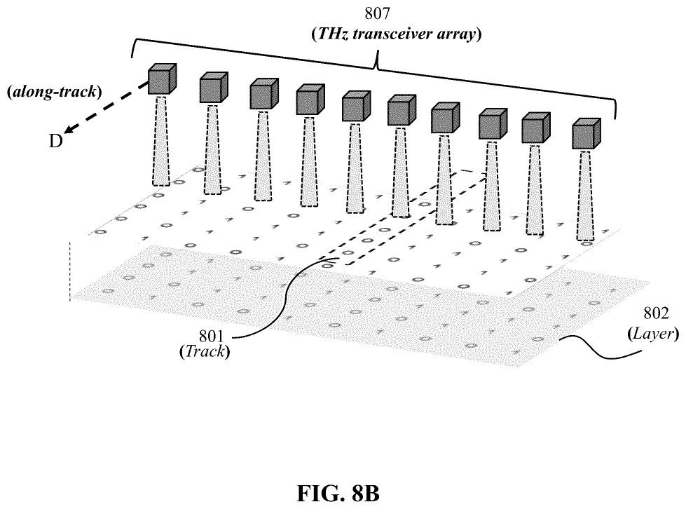

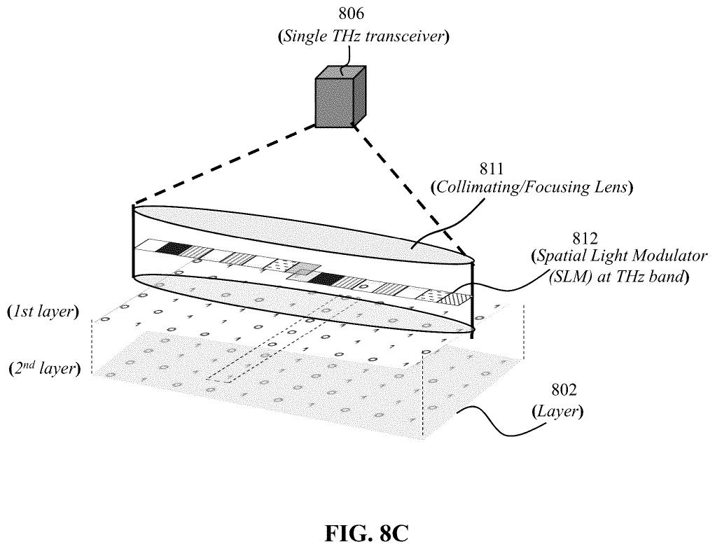

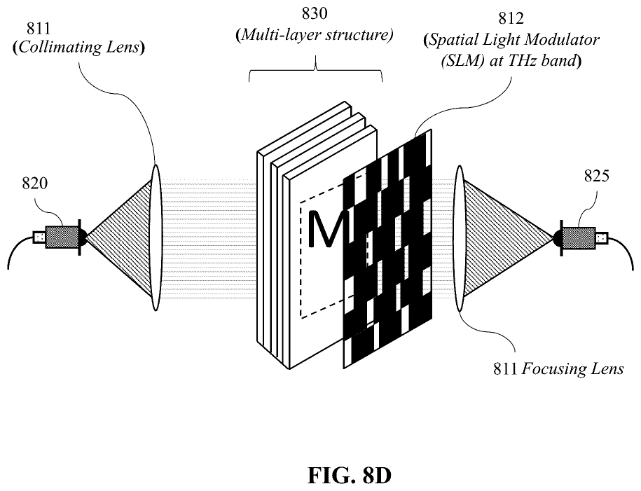

FIG. 8A shows a schematic of using a single THz transceiver 806 to mechanically scan the multi-layer 802, multi-track 801, multi-level scale, i.e., across the track and along the track, to receive the reflected waveforms to identify the coded pattern for the position. Alternatively, the single THz transceiver can be a transmitter, wherein the transmitted THz waveform passes through the multi-layered scale and is received by a receiver 809. In particular, the transmitted THz waveform passes through the multi-layered/multi-level scale, and the THz waveform continues directly to the receiver 809 to identify the coded pattern for the position.

FIG. 8B shows a schematic of using multiple THz transceivers 807 (or a THz transceiver array), wherein each THz transceiver in the array can be aligned with a single track 801. Each THz transceiver may also be able to receive the reflected waveforms to identify the coded pattern of corresponding track for the position. The THz transceiver array 807 can move simultaneously along the track direction D for absolute positioning.

FIG. 8C shows a schematic of using a single THz transceiver 806 together with collimating/focusing lenses 811, spatial light modulators 812 at the THz band. The single transceiver 806 sends the THz waveform to the collimating lens 811. The waveform is collimated by the collimating lens 811 and then modulated by the spatial light modulator 812 with random patterns. The reflected THz waveform passes through the focusing lens 811 and detected by the single THz transceiver 806.

FIG. 8D shows a schematic of using a THz transmitter 820 and a THz receiver 825 separated on both sides of a multi-layer non-overlapping sample 830, along with collimating/focusing lenses 811, spatial light modulators (SLM) 812 at the THz band. This acquisition is similar to FIG. 8C but in a transmission mode. The multi-layer non-overlapping sample 830 may be a layered object such as a stack of inked papers. The THz transmitter 820 may be a fiber coupled photoconductive antenna transmitting waveforms into the sample 830. These waveforms upon propagation through the sample 830 are received by the THz receiver 825 on the other side of the sample 830. The SLM may be any random pattern on a planar screen.

In the configurations illustrated in FIGS. 8A-8D, the THz transceiver(s) provide the measurement of intensities of the wave modified by propagation through the scene. An image processing system such as the one illustrated with reference to FIG. 1A may collect these measurements and process them in the manner described with reference to various example embodiments to generate the images of the structure of the scene.

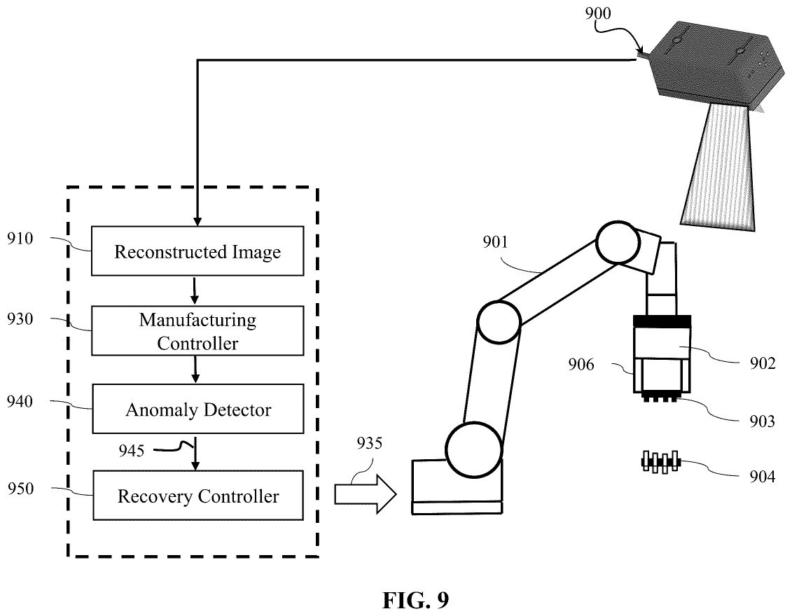

FIG. 9 shows a schematic of an automation system including a scanner 900 according to some embodiments. In these embodiments, the image reconstruction is used for anomaly detection to control a process of manufacturing a target object. The automation system includes one or combination of a manufacturing controller 930 configured to control 935 an equipment 901 manufacturing the target object, and an anomaly detector 940 configured to inspect the reconstructed image 910 of the layer of target object after and/or during the manufacturing process, and a recovery controller 950 configured to cause a modification of the control of the equipment based on a negative result 945 of the inspection.

For example, the anomaly detector 940 may compare the reconstructed image 910 with a test image, and if a comparison error is greater than a threshold, the recovery controller stops the controlling 935. Additionally, or alternatively, the recovery controller can alter the control 935 without stopping the manufacturing process. For example, in one embodiment, the equipment 901 paints a surface of a body of a vehicle. The reconstructed image 910 may include density information for each layer of the paint, and recovery controller can request the manufacturing controller to add another layer of the paint of the density is not adequate.

In some example embodiments, the equipment 901 may be a robotic assembly performing an operation including an insertion of a component along an insertion line to assemble the target object. The robotic assembly includes a robotic arm that inserts a first component 903 into a second component 904. In some embodiments, the robotic arm includes a wrist 902 for ensuring multiple degrees of freedom of moving the component 903. In some implementations, the wrist 902 has a gripper 906 for holding the mobile component 903. Examples of target object include a semiconductor, a transistor, a photonic integrated circuit (PIC), etc.

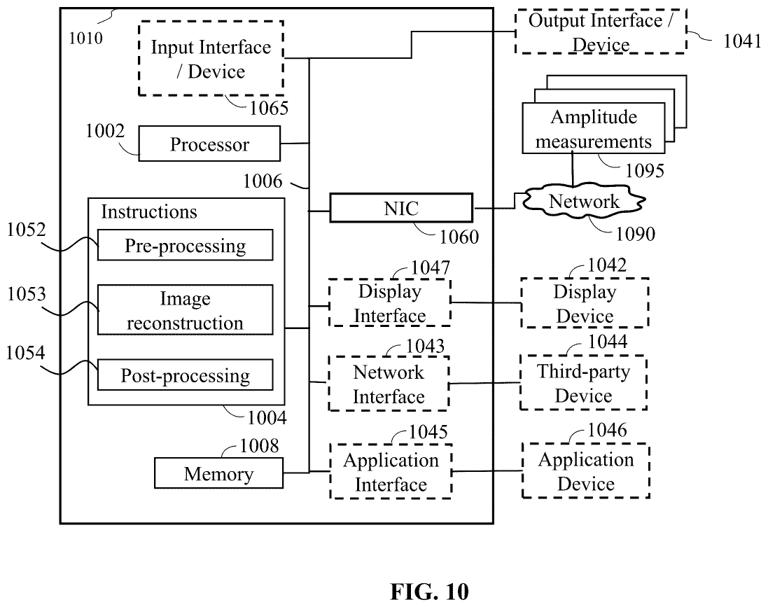

FIG. 10 illustrates a block diagram of a computer-based information system 1010 in accordance with some embodiments. The information system 1010 can include a processor 1002 configured to execute stored instructions, as well as a memory 1008 that can store instructions executable by the processor. The processor 1002 can be a single core processor, a multi-core processor, a computing cluster, or any number of other configurations. The memory 1008 can include random access memory (RAM), read only memory (ROM), flash memory, or any other suitable non-transitory computer readable storage medium. The processor 1002 is connected through a bus 1006 to one or more input interface/device 1065 and output interface/device 141.

These instructions 1004 stored in the memory 1008 can implement image recovery of a structure of the target object. For example, the instructions can include a pre-processing 1052, such as filtering, partitioning, time-gating, peak finding, and denoising on the measurements 1095 of the reflected wave. The instructions further provide the implementations of the image reconstruction 1053 according to different embodiments. Optionally, the instructions can include post-processing to further improve the quality of the reconstructed images and/or to combine the reconstructed images of the layers of the target object to produce an image of the structure of the target object.

The information system 1010 can include an output interface/device 1041 to render the estimated information. In some embodiments, the output interface 1041 may include a printer interface (not shown) adapted to connect the encoder to a printing device (not shown). In some embodiments, a display interface 1047 can be adapted to connect the processor 1002 to a display device 1042. The display device 1042 can include a camera, computer, scanner, mobile device, webcam, or any combination thereof. In some embodiments, a network interface 1043 is adapted to connect the processor 102 and also potentially to one or several third-party devices 1044 on the network 1090. In some embodiments, an application interface 1045 can be used to submit the estimated information to an application device 1046, such as a controller, by non-limiting example, controlling the motion of the mobile object.

The information system 1010 can also include an input interface 1065 to receive the amplitude measurements 1095 of the amplitude of the modified waves. For example, a network interface controller (NIC) 1060 can be adapted to connect the information system 1010 through the bus 1006 to the network 1090. The network 1090 can be implemented as a wired or wireless network. Through the network 1090 and/or other implementations of the input interface 1065, the measurements 1095 of the amplitude of the reflected signal can be downloaded and stored for storage and/or further processing.

The above description provides exemplary embodiments only, and is not intended to limit the scope, applicability, or configuration of the disclosure. Rather, the above description of the exemplary embodiments intends to provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may have been shown without unnecessary detail in order to avoid obscuring the embodiments. Further, reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments. The above-described embodiments of the present disclosure can be implemented in any of numerous ways. For example, the embodiments may be implemented using hardware, software, or a combination thereof. When implemented in software, the software code can be executed on any suitable processor or collection of processors, whether provided on a single computer or distributed among multiple computers. Such processors may be implemented as integrated circuits, with one or more processors in an integrated circuit component. Though, a processor may be implemented using circuitry in any suitable format.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

What is claimed is:

1. A scanner for image reconstruction of a structure of a scene, comprising:
a memory configured to store instructions; and
at least one processor configured to execute the instructions to cause the scanner to:
collect measurements of intensities of a wave over a period of time, wherein the intensities of the wave are modified by propagation of the wave in the scene;
collect depth information indicative of the structure of the scene at different values of depth of the scene, wherein the different values of depth correlate with different time segments forming the period of time;
process the measurements with a guided recurrent neural network to sequentially learn features of the structure of the scene using the depth information as a guidance, wherein the depth information is aligned with the measurements according to the correlation between the depth values and the different time segments; and
render one or multiple images indicative of the features of the structure learned by the recurrent neural network.

2. The scanner of claim 1, wherein the at least one processor is further configured to:
process the measurements with a sparse reconstruction network to recover a sparse structure of the scene along its depth; and
quantize the sparse structure into a sequence of bins corresponding to a sequence of depth segments along the depth of the scene, such that each bin includes a quantized value of the sparse structure for a corresponding depth segment of the sequence of depth segments, wherein the sequence of bins has a one-to-one mapping with a sequence of time segments forming the period of time.

3. The scanner of claim 2, wherein the guided recurrent neural network includes a sequence of recurrent units that sequentially learn the features of the structure of the scene, wherein each of the recurrent units is associated with a time segment from the different time segments forming the period of time.

4. The scanner of claim 3, wherein a recurrent unit of the sequence of recurrent units is configured to learn at least some features of the features of the structure of the scene based on an output of a previous iteration, a portion of the measurements collected over an associated time segment, and a quantized value of a bin mapped to the associated time segment.

5. The scanner of claim 4, wherein the quantized value of the bin is a weight scaling an output of the recurrent unit.

6. The scanner of claim 4, wherein the quantized value of the bin is a mask filtering an output of the recurrent unit.

7. The scanner of claim 4, wherein the quantized value of the bin is a function of the depth segment modifying an output of the recurrent unit.

8. The scanner of claim 1, wherein the scene includes a target object and wherein the rendered one or multiple images include images of one or multiple layers of the target object.

9. The scanner of claim 8, further comprising:
an emitter configured to emit a set of waves in parallel directions of propagation to penetrate a sequence of layers of the target object forming the structure of the target object; and
a receiver configured to measure intensities of the set of waves modified by penetration through the layers of the target object.

10. An automation system including the scanner of claim 8, the automation system comprising:
a manufacturing controller configured to control an equipment configured to operate on the target object;
an anomaly detector configured to inspect the images of the one or multiple layers of the target object; and
a recovery controller configured to cause a modification of the control of the equipment based on a result of the inspection.

11. The scanner of claim 1, wherein the at least one processor is further configured to produce an image of the structure of the scene, based on the rendered one or multiple images.

12. The scanner of claim 1, wherein the at least one processor is configured to collect the depth information from a storage device.

13. A method of image reconstruction of a structure of a scene, comprising:
collecting measurements of intensities of a wave over a period of time, wherein the intensities of the wave are modified by propagation of the wave in the scene;
collecting depth information indicative of the structure of the scene at different values of depth of the scene, wherein the different values of depth correlate with different time segments forming the period of time;
processing the measurements with a guided recurrent neural network to sequentially learn features of the structure of the scene using the depth information as a guidance, wherein the depth information is aligned with the measurements according to the correlation between the depth values and the different time segments; and
rendering one or multiple images indicative of the features of the structure learned by the recurrent neural network.

14. The method of claim 1, further comprising:
processing the measurements with a sparse reconstruction network to recover a sparse structure of the scene along its depth; and
quantizing the sparse structure into a sequence of bins corresponding to a sequence of depth segments along the depth of the scene, such that each bin includes a quantized value of the sparse structure for a corresponding depth segment of the sequence of depth segments, wherein the sequence of bins has a one-to-one mapping with a sequence of time segments forming the period of time.

15. The method of claim 13, further comprising:
controlling transmission of a set of waves in parallel directions of propagation to penetrate a sequence of layers of the target object forming the structure of the target object; and
measuring intensities of the set of waves modified by penetration through the layers of the target object.

16. The method of claim 13, further comprising producing an image of the structure of the scene, based on the rendered one or multiple images.

17. A non-transitory computer-readable storage medium having stored thereon a program executable by a processor for performing a method for image reconstruction of a structure of a scene, the method comprising:
collecting measurements of intensities of a wave over a period of time, wherein the intensities of the wave are modified by propagation of the wave in the scene;
collecting depth information indicative of the structure of the scene at different values of depth of the scene, wherein the different values of depth correlate with different time segments forming the period of time;
processing the measurements with a guided recurrent neural network to sequentially learn features of the structure of the scene using the depth information as a guidance, wherein the depth information is aligned with the measurements according to the correlation between the depth values and the different time segments; and
rendering one or multiple images indicative of the features of the structure learned by the recurrent neural network.

18. The non-transitory computer-readable storage medium of claim 17, further comprising:
processing the measurements with a sparse reconstruction network to recover a sparse structure of the scene along its depth; and
quantizing the sparse structure into a sequence of bins corresponding to a sequence of depth segments along the depth of the scene, such that each bin includes a quantized value of the sparse structure for a corresponding depth segment of the sequence of depth segments, wherein the sequence of bins has a one-to-one mapping with a sequence of time segments forming the period of time.

19. The non-transitory computer-readable storage medium of claim 17, further comprising:
controlling transmission of a set of waves in parallel directions of propagation to penetrate a sequence of layers of the target object forming the structure of the target object; and
measuring intensities of the set of waves modified by penetration through the layers of the target object.

20. The non-transitory computer-readable storage medium of claim 17, further comprising producing an image of the structure of the scene, based on the rendered one or multiple images.
